(19) United States
(12) Patent Application Publication
(10) Pub. No.: US 2005/0063297 A1
(43) Pub. Date: Mar. 24, 2005

(54) Receiver for burst signal including known signal

(76) Inventors: Ren Sakata, Yokohama-shi (JP); Shinya Harada, Yokohama-shi (JP); Kazumi Sato, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/914,116

(22) Filed: Aug. 10, 2004

(30) Foreign Application Priority Data
Aug. 11, 2003 (JP) 2003-207164

(51) Int. Cl. H04J 11/00

(52) U.S. Cl. 370/208; 370/210; 370/503

(57) ABSTRACT

A burst signal receiver comprises a correlation computation unit configured to compute a correlation value between a received known signal and a generated known signal, a moving average calculator to moving-average the correlation value to obtain a moving average value, a peak detector to detect a peak value of the moving average value and a peak position thereof for each of the constant periods; and a synchronization determination unit configured to determine a synchronization position according to a given condition using the peak value and the peak position.

### CROSS-REFERENCE TO RELATED APPLICATIONS

This application is based upon and claims the benefit of priority from prior Japanese Patent Application No. 2003-207164, filed Aug. 11, 2003, the entire contents of which are incorporated herein by reference.

### BACKGROUND OF THE INVENTION

1. Field of the Invention

The present invention relates to a receiver receiving a burst signal including a repetitive known signal such as an OFDM (Orthogonal Frequency Division Multiplexing) signal, and more particularly to a technique to establish a timing synchronization.

2. Description of the Related Art

A wireless LAN (Local Area Network) device attracts attention as a connecting measure for a network device and becomes widespread rapidly. One of technical requests for a wireless LAN device is implementation of stable high throughput communication. To satisfy this request, a receiver has to receive precisely a message transmitted by a transmitter and reduce overhead causing by re-transmission. It is important for receiving the message surely that the receiver establishes a timing synchronization with respect to the transmitter.

IEEE (Institute of Electrical and Electronics Engineers) or ETSI (the European Telecommunication Standards Institute) recommends a communication method to establish a timing synchronization by a repeat part of a known signal. For example, in IEEE 802.11a, which is one of wireless LAN standards, the known signal of 0.8 μsec as referred to as a short preamble is repeatedly transmitted ten times at the beginning of packet transmission. In the receiver, a synchronization unit detects the end time point of the tenth short preamble, that is, the rearmost end of the repetitive known signal in the preamble. The rearmost end is determined to be a reference time position (synchronization position).

A Japanese Patent Laid-Open No. 2001-148679 discloses a method of using an autocorrelation output obtained on the received signal by detecting such a repetitive known signal, to establish a timing synchronization precisely. This method utilizes that the repetitive known signal has a constant strong autocorrelation. The repetitive known signal is detected by obtaining the autocorrelation that is correlation between the received signal and the signal obtained by delaying the received signal by a repetitive period of the known signal. In other words, the dropped point of the autocorrelation output is detected. This is considered to be the rearmost end of the repetitive known signal thereby to be determined as a synchronization position.

In the method disclosed by Japanese Patent Laid-Open No. 2001-148679, if the autocorrelation output on the repetitive known signal falls due to some causes, or it fluctuates in terms of time, the fall point of the autocorrelation output is missed or erroneously detected. As a result, it is very likely that the synchronization position is erroneously determined. Such degradation of the autocorrelation output is due to a noise mixed in a transmission signal on a propagation path. Because the noise has no periodicity, it causes the decrease of the autocorrelation output and further the fluctuation thereof.

### BRIEF SUMMARY OF THE INVENTION

The object of the present invention is to provide a receiver, which can suppress the influence of noise, and realize a correct timing synchronization.

An aspect of the present invention provides a receiver to receive a burst signal including a first known signal repeated in a plurality of continuous constant periods, the receiver comprising: a generator to generate a second known signal in correspondence with the first known signal; a correlation computation unit configured to compute a correlation value between the first known signal and the second known signal; a moving average calculator to moving-average the correlation value to obtain a moving average value; a peak detector to detect a peak value of the moving average value and a peak position thereof for each of the constant periods; and a synchronization determination unit configured to determine a synchronization position according to a given condition using the peak value and the peak position.

### BRIEF DESCRIPTION OF THE SEVERAL VIEWS OF THE DRAWING

FIG. 1 is a block diagram of a receiver according to an embodiment of the present invention.

FIG. 2 is a diagram showing an example of a received signal.

FIG. 3 is a block diagram of a synchronization unit according to the embodiment of the present invention.

FIG. 4 is a diagram showing an example of a moving average value waveform provided from a moving average calculation unit.

FIG. 5 is a block diagram of a synchronization determination unit.

FIG. 6 is a block diagram of another synchronization determination unit.

FIG. 7 is a block diagram of a synchronization unit according to another embodiment of the present invention.

### DETAILED DESCRIPTION OF THE INVENTION

(Entire Configuration of a Receiver Apparatus)

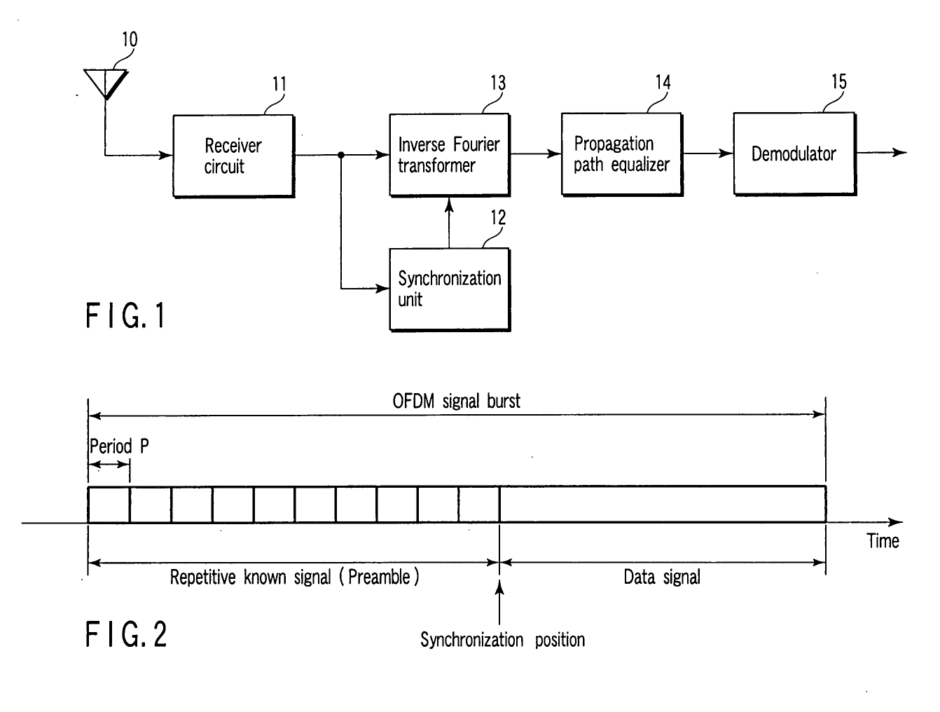

As shown in FIG. 1, a RF signal transmitted with a transmitter (not shown) is received with a receiving antenna 10 in a receiver according to the embodiment of the present invention. An output signal from the receiving antenna 10 is input into a receiver circuit 11. The received RF signal is, for example, an OFDM (orthogonal frequency division multiplex) signal.

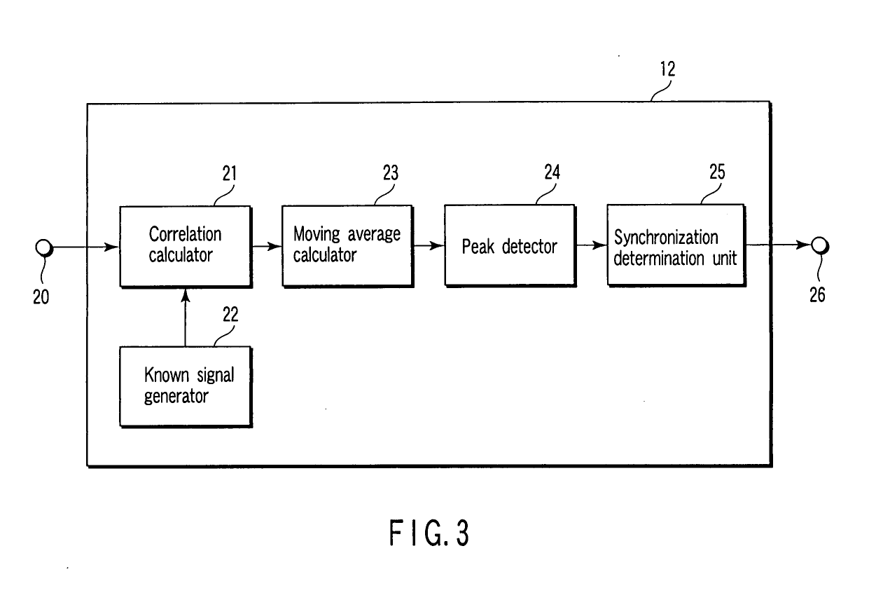

The OFDM signal is, for example, a burst signal as shown in FIG. 2, wherein a synchronization preamble, a propagation estimation preamble and so on are arranged on its head, and data signal follows the preamble. In the preamble, the same known signal is repeated in a constant period P. The data signal includes one or more information symbols. Each information symbol comprises a plurality of subcarrier signals.

The receiver circuit 11 amplifies, frequency-converts and analog-to-digital converts the received OFDM signal to generate a digital baseband signal. The digital baseband signal output from the receiver circuit 11 is referred to as a received signal hereinafter.

The received signal from the receiver circuit 11 is input to a synchronization unit 12 and an inverse Fourier transformer 13. The synchronization unit 12 synchronizes in timing a transmitter using the received signal, so that a reference time position referred to as an synchronization position is determined. The timing synchronization is a process to detect a position of a symbol or a bit position from, for example, the received signal, in the case of the present embodiment to receive the OFDM signal. In this case, the synchronization position is the head position of an information symbol of a data signal, for example, FIG. 2, that is, the rearmost end of a preamble formed of a repetitive known signal. A concrete example of the synchronization unit 12 is described in detail later.

The inverse Fourier transformer 13 subjects to the received signal from the receiver circuit 11 to inverse FFT (inverse Fourier transform). The inverse Fourier transformer 13 sets an interval referred to as an inverse FFT window to the received signal periodically, extracts each interval of the inverse FFT window, and subjects it to FFT. In this case, the inverse FFT window is set according to the synchronization position determined by the synchronization unit 12. In other words, information indicating the synchronization position obtained from the synchronization unit 12 is supplied to the inverse Fourier transformer 13. The head of the inverse FFT window matches a timing synchronization based on this information, resulting in performing the timing synchronization. In other words, the inverse FFT window in the receiver is set to match the FFT window in the transmitter in time.

The inverse Fourier transformer 13 extracts subcarrier signals from the received signal of the receiver circuit 11 by the inverse FFT process. Each of the subcarrier signals is input to an equalizer 14. The OFDM signal is subjected to an equalizing process to remove distortion sustained on the propagation path. Thereafter, it is input to a demodulator 15. In the demodulator 15, a demodulation process is done to the received signal after equalization by an appropriate demodulation timing based on the timing synchronization process to reproduce a transmission data stream. Because the processes of the equalizer 14 and demodulator 15 are known, detailed description is omitted here.

(First Example of the Synchronization Unit 12)

FIG. 3 shows a configuration of the synchronization unit 12 according to the first example. The received signal from the receiver circuit 11 is input to a correlation computation unit 21 via an input terminal 20 to compute a correlation value with respect to the known signal generated by a known signal generator 22. The known signal included in the preamble part of the received signal is referred to as a first known signal, and the known signal generated by the known signal generator 22 is referred to as a second known signal. The second known signal is generated as the same signal as the first original known signal.

The correlation value calculated with the correlation computation unit 21 indicates a large value, when the first known signal included in the preamble part of the received signal and the second known signal generated by the known signal generator 22 agree or resemble each other. When the first known signal and the second known signal do not agree or resemble each other, the correlation value indicates a small value. The known signal generator 22 generates the second known signal while shifting it in a single direction one by one time. The correlation value computation of the correlation computation unit 21 is done repeatedly whenever the second known signal is shifted by one time. As a result, the correlation value is output continually repeatedly.

The correlation value computed by the correlation computation unit 21 is input to a moving average calculation unit 23 to calculate a moving average value. The moving average is an operation to obtain an arithmetic mean or an average of a quantity of data gathered over a period of time. The moving average value obtained by this operation smoothes a noise component. In the case of the present embodiment, by calculating a moving average value on the correlation value from the correlation calculation unit 21 with the moving average calculation unit 23, the noise component causing a determination error of the synchronization position can be smoothed.

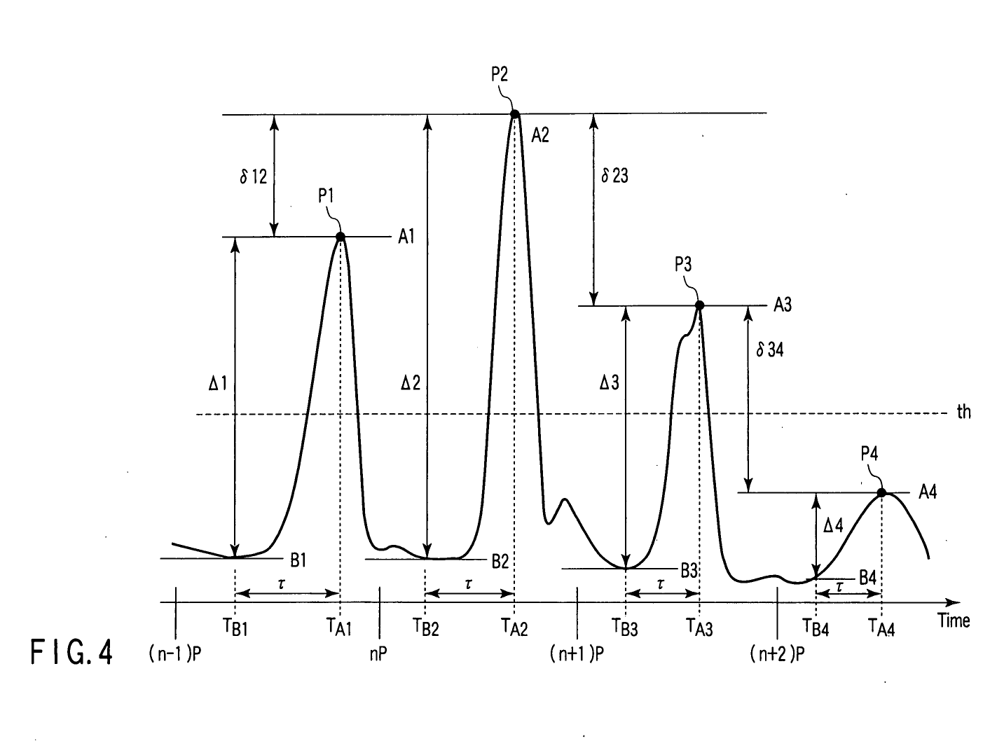

The moving average calculation unit 23 comprises a multi-stage shift register of a plurality of stages that holds only the constant number of past input values (correlation value from a correlation computation unit 21). The moving average value is obtained by outputting the average of held data of each stage of the shift register. FIG. 4 shows an example of a moving average value waveform, which is an output of the moving average calculation unit 23.

The moving average value calculated by the moving average calculation unit 23 is input to a peak detector 24. The peak detector 24 divides the moving average value waveform into time intervals corresponding to repetitive periods P of the first known signal, and searches for the peak of the moving average value for each time interval to detect a peak value and a peak position. The moving average value waveform shown in FIG. 4 has peaks P1-P4. The peak detector 24 detects peak values A1 to A4, which are values of the peaks P1 to P4, and peak positions T_{A1} to T_{A4}, which are time positions of the peaks P1 to P4. The peak detector 24 outputs information of the peak values A1 to A4 and the peak positions T_{A1} to T_{A4}.

The information on the peak values and peak positions output from the peak detector 24 is input to a synchronization determination unit 25.

The synchronization determination unit 25 determines a synchronization position, that is, a reference time position for use in a timing synchronization by using the peak value and peak position detected by peak detector 24, and outputs information indicating the synchronization position to an output terminal 26. The concrete configuration of the synchronization determination unit 25 will be described in detail later.

In the present embodiment as described above, the correlation value calculated by the correlation calculation unit 21 is averaged by the moving average calculation unit 23 to obtain a moving average value. The peak detection is performed on this moving average value. The noise component included in the received signal is canceled by averaging in calculating this moving average value. Consequently, the influence of the noise component of the received signal on the peak detection is reduced. Therefore, this embodiment makes it possible to determine the synchronization position more precisely in comparison with a conventional method of detecting a peak of an autocorrelation output.

(An Example 1 of the Synchronization Determination Unit 25)

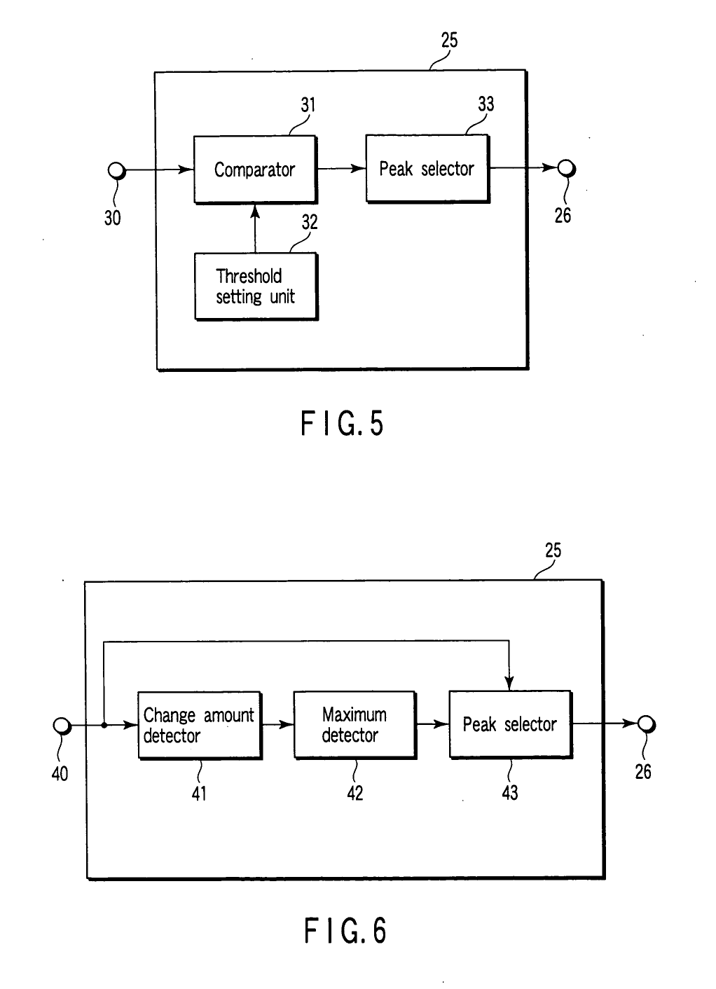

An example of the synchronization determination unit 25 is shown in FIG. 5. This synchronization determination unit 25 comprises a comparator 31, a threshold setting unit 32, and a peak selector 33. The information on the peak value and peak position from the peak detector 24 is input to the comparator 31 via an input terminal 30. The comparator 31 compares the peak value input from the input terminal 30 with the threshold th set by the threshold setting unit 32. As a result of this comparison, the comparator 31 determines that the interval in which a peak whose peak value exceeds the threshold th occurs corresponds to the interval in which the first known signal appears repeatedly, and outputs information on all peak positions in the interval, namely all peak positions at which the peak value exceeds the threshold th.

The information of the peak position output from the comparator 31 is input to the peak selector 33. The peak selector 33 selects a peak position which is most suitable for the synchronization position from among the peak positions corresponding to the peaks exceeding the threshold, and outputs information indicating the synchronization position to the output terminal 26. The latest peak position among all peak positions corresponding to the peak values exceeding the threshold th is determined to be the end of the preamble of FIG. 2 that is a repeat part of the first known signal (head position of an information symbol of data interval). The comparator 31 selects the latest peak position as a peak position which is most suitable for the synchronization position, and determine it as a synchronization position. The information indicating the determined synchronization position is output via the output terminal 26, and supplied to the inverse Fourier transformer 13 shown in FIG. 1.

Consider the case that the peak values A1 to A4 and the peak positions T_{A1} to T_{A4} of the moving average value waveform shown in FIG. 4 are detected by the peak detector 24. The comparator 31 compares the peak values A1 to A4 with the threshold th set by the threshold setting unit 32. In this example, since the peak values A1, A2, A3 corresponding to the values of the peaks P1, P2, P3 exceed the threshold th as shown in FIG. 4, the comparator 31 outputs information of the peak position T_{A1}, T_{A2}, T_{A3} corresponding to time positions of peaks P1, P2, P3 to the peak selector 33. The peak selector 33 determines as the synchronization position the latest peak position T_{A3} among the peak positions T_{A1}, T_{A2}, T_{A3}, and outputs information of the peak position T_{A3} to the output terminal 26.

The synchronization determination unit 25 shown in FIG. 5 has a configuration that is easy in packing, and detects the end of the preamble part corresponding to the repetitive known signal based on a peak detection using a constant threshold th, and determines a synchronization position. Hence, the synchronization determination unit 25 is suitable for use in circumstances wherein a propagation environment does not almost change and a direct wave is strongly received.

(An Example 2 of the Synchronization Determination Unit 25)

FIG. 6 shows another example of the synchronization determination unit 25. This synchronization determination unit 25 comprises a change amount detector 41, a maximum detector 42, and a peak selector 43. The information on the peak value and peak position from the peak detector 24 shown in FIG. 3 is input via an input terminal 40 to a change amount detector 41.

The change amount detector 41 calculates a change amount between two adjacent peak values corresponding to two adjacent periods P, and outputs information indicating the change amount together with information of each peak value. The change amount between two adjacent peak values can use a difference between the peak values of, for example, two adjacent periods P.

The change amount detected by the change amount detector 41 indicates a large value in the preamble part that the first known signal is repeated. Consequently, the maximum detector 42 detects the maximum value of change amount derived by the change amount detector 41, and outputs information of the peak value to give the maximum change amount. The information of the peak value output from the maximum detector 42 is input to the peak selector 43. The peak selector 43 selects the peak position most suitable for the synchronization position based on information of the peak value and peak position from the peak detector 24 shown in FIG. 3 and information of the maximum value detected by the maximum detector 42. Concretely, the peak selector 43 selects as the synchronization position an earlier peak position from among peak positions between two adjacent periods providing the maximum value detected by, for example, the maximum detector 42, and determines the synchronization position. The information indicating this determined synchronization position is output to the output terminal 26.

Consider the case that the peak values A1 to A4 and the peak positions T_{A1} to T_{A4} of the moving average value waveform shown in FIG. 4 are detected by the peak detector 24, for example. In this case, the change amount detector 41 outputs information of change amounts Δ12=A1−A2, Δ23=A2−A3, and Δ34=A3−A4 of the peak values of two adjacent periods, that is, periods (1): (n−1)P−nP and nP−(n+1)P, periods (2): nP−(n+1)P and (n+1)P−(n+2)P, and periods (3): (n+2)P−(n+3)P, and information of peak positions T_{A1} to T_{A4}. The maximum detector 42 compares the change amounts Δ12 to Δ34 outputs information of the peak positions T_{A3} and T_{A4} corresponding to Δ34, because Δ34 is maximum in the example of FIG. 4. The peak selector 43 selects and outputs as the synchronization position the peak position T_{A3} that is earlier in terms of time among the peak positions T_{A3} and T_{A4}.

The synchronization determination unit 25 shown in FIG. 6 detects the rearmost end of the preamble part formed of the repetitive known signal using a difference between the peak values in two adjacent periods as an change amount and determines the synchronization position. Therefore, when a constant DC offset is superposed by the received signal, it is possible to determine the synchronization position easily. Since the change amounts of the peak values in two adjacent periods are compared, even if the periodic signal sustains distortion due to multi-pass and so on, it is not influenced by the distortion.

The change amount detector 41 detects a ratio between the peaks in two adjacent periods in stead of a difference between the peak values in two adjacent periods. The position at which the ratio between the peaks becomes minimum is set to the synchronization position. For this reason, even if the received signal is amplified or attenuated with different magnifications every signal, it is possible to determine the synchronization position easily.

(Second Example of the Synchronization Unit 12)

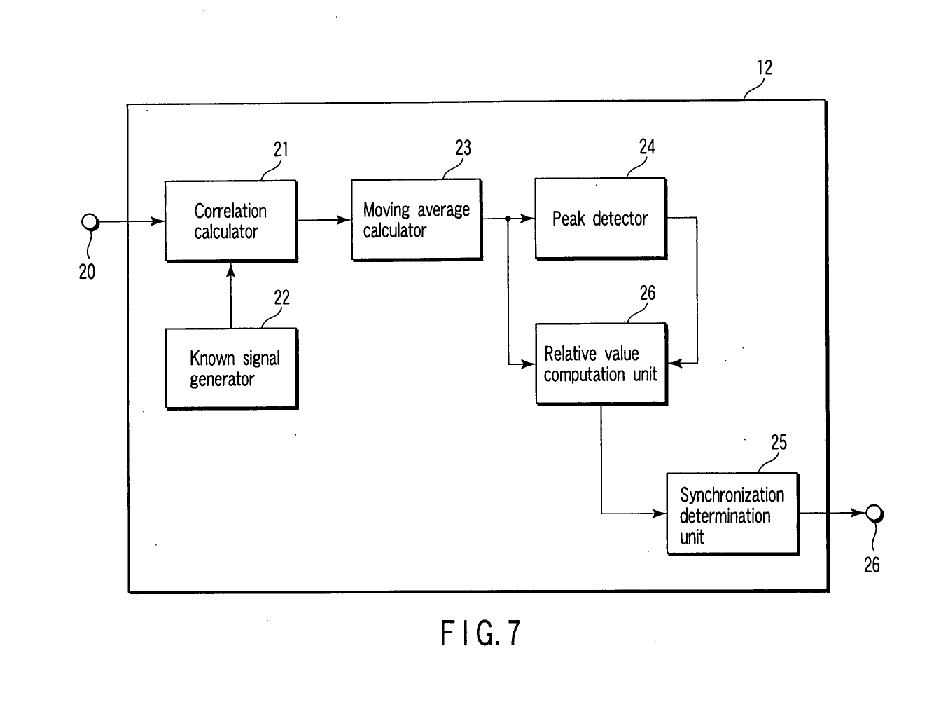

Another configuration example of the synchronization unit 12 is described with reference to FIG. 7. In the synchronization unit 12 shown in FIG. 7, a relative value computation unit 27 is interposed between the peak detector 24 and synchronization determination unit 25 of FIG. 3. In the second example, like reference numerals are used to designate like structural elements corresponding to those like in the first example and any further explanation is omitted for brevity's sake. In the synchronization unit 12 of FIG. 7, information of a moving average value calculated by the moving average calculation unit 23 on the correlation value calculated by the correlation calculation unit 21, information of a peak value in each of repetitive periods P that is detected on a moving average value by the peak detector 23, and information of the peak position corresponding to the peak value are input to the relative value computation unit 27.

The relative value computation unit 27 computes a relative value of each peak value detected by the peak detector 24, using as a reference value a moving average value (moving average value around a peak in each period) from the moving average calculation unit 23 at a time point preceding from each peak position by a time less than the period P. The relative value computation unit 27 determines a time τ in the period P beforehand, and computes a difference between the peak value and the reference value as a relative value, using as a reference value the moving average before the peak position by the time τ. The relative value computation unit 27 outputs information of the relative value together with information of the peak position. The synchronization determination unit 25 determines a synchronization position based on the relative value and information of the peak position that are provided by the relative value computation unit 27.

The moving average value waveform shown in FIG. 4 is provided by the moving average calculation unit 23 like the above example. Consider the case that the peak values A1 to A4 and the peak positions T_{A1} to T_{A4} of the moving average value waveform shown in FIG. 4 are detected by the peak detector 24. In this case, at first, the relative value computation unit 27 extracts the moving average value B1 at a position T_{B1}=T_{A1}−τ and calculates a relative value Δ1=A1−B1. Then, the relative value computation unit 27 repeats the similar process in correspondence with each peak position and calculates the relative values Δ2 to Δ4.

The information indicating the relative value output from the relative value computation unit 27 is input to the synchronization determination unit 25 together with information indicating the peak position. The synchronization determination unit 25 selects an optimum synchronization position from each relative value and peak position, and outputs information indicating the synchronization position to the output terminal 26.

The relative value computed by the relative value computation unit 27 is an index indicating acuity of the peaks P1 to P4. It is thought that reliability of a synchronization determination becomes higher as the peak is sharper. Therefore, reliability of the synchronization determination position can be improved. Further, when the relative value computation unit 27 computes as a relative value a difference between the reference value and the peak value, influence of a DC offset included in the received signal can be reduced.

The relative value may use a ratio between the reference value and the peak value. In this case, Δ′=A1/B1 is set in stead of Δ1, to calculate Δn′ (n is an integer not less than 1). The position of the last Δn′ which is larger than a given threshold set beforehand is determined to be the synchronization position. As a result, it possible to determine the synchronization position easily, even if the received signal is amplified or attenuated with a different magnification every signal.

The synchronization determination unit 25 in FIG. 7 may basically similar to the synchronization determination unit 25 in FIG. 3, and is configured as shown in FIG. 5 or FIG. 6, for example. However, the input to the synchronization determination unit 25 in FIG. 3 is information of the peak value and peak position provided by the peak detector 24. In contrast, the input to the synchronization determination unit 25 in FIG. 7 is information of the relative value provided by the relative value computation unit 27 and the peak position provided by the peak detector 24. As a result, the synchronization determination unit 25 can be configured like FIG. 5 or FIG. 6.

In other words, in the synchronizing determination unit 25 shown in FIG. 5, the comparator compares the relative value and the threshold set with the threshold setting unit 32 beforehand to search for all peak positions that the relative value exceeds the threshold. The peak selector 33 selects as an optimum peak position the latest peak position from among the peak positions obtained by the comparator 31, and determines it as the synchronization position.

On the other hand, in the synchronization determination unit 25 shown in FIG. 6, the change amount detector 41 derives change amounts (Δ2-1, Δ3-Δ2, . . . in an example shown in FIG. 4) of the relative values between two adjacent periods P. The maximum detector 42 detects the maximum value of the change amounts. The peak selector 43 selects as the synchronization position the peak position earlier in terms of time among the relative values of two adjacent periods providing the maximum value. In the example shown in FIG. 4, T_{A3} is selected as the synchronization position, because the value of Δ4-Δ3 becomes maximum.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A receiver to receive a burst signal including a first known signal repeated in a plurality of continuous constant periods, the receiver comprising:
a generator to generate a second known signal in correspondence with the first known signal;
a correlation computation unit configured to compute a correlation value between the first known signal and the second known signal;
a moving average calculator to moving-average the correlation value to obtain a moving average value;
a peak detector to detect a peak value of the moving average value and a peak position thereof for each of the constant periods; and
a synchronization determination unit configured to determine a synchronization position according to a given condition using the peak value and the peak position.

2. The receiver according to claim 1, wherein the synchronization determination unit comprises a comparator to compare the peak value with a threshold to detect the peak position corresponding to the peak value exceeding the threshold, and a peak selector to select a latest peak position as the synchronization position.

3. The receiver according to claim 2, which includes a threshold setting unit connected to the comparator and configured to input the threshold to the comparator.

4. The receiver according to claim 1, wherein the peak detector including means for searching for peaks of moving average values in time intervals corresponding to the constant periods to detect peak values and peak positions.

5. The receiver according to claim 4, wherein the synchronization determination unit comprises a comparator to compare the peak values with a threshold to detect the peak positions corresponding to the peak values exceeding the threshold, and a peak selector to select as the synchronization position a latest peak position from the peak positions corresponding to the peak values exceeding the threshold.

6. The receiver according to claim 5, which includes a threshold setting unit connected to the comparator and configured to input the threshold to the comparator.

7. The receiver according to claim 5, wherein the burst signal includes an orthogonal frequency division multiply signal including a preamble including the known signal and data following the preamble, and the synchronization determination unit is configured to determine a rearmost end of the preamble as the synchronization position.

8. The receiver according to claim 4, wherein the synchronization determination unit comprises a change amount detector to derive a change amount between the peak values in adjacent time intervals of the time intervals, a maximum detector to detect a maximum change amount, and a peak selector to select as the synchronization position a peak position corresponding to an earlier one of the adjacent time intervals including the peak values indicating the maximum change amount therebetween.

9. The receiver according to claim 8, wherein the burst signal includes an orthogonal frequency division multiply signal including a preamble including the known signal and data following the preamble, and the synchronization determination unit is configured to determine a rearmost end of the preamble as the synchronization position.

10. The receiver according to claim 1, wherein the burst signal includes an orthogonal frequency division multiply signal including a preamble including the known signal and data following the preamble, and the synchronization determination unit is configured to determine a rearmost end of the preamble as the synchronization position.

11. A receiver to receive a burst signal including a first known signal repeated in a plurality of constant periods, the receiver comprising:
a known signal generator to generate a second known signal;
a correlation computation unit configured to compute a correlation value between the first known signal and the second known signal;
a moving average calculation unit configured to moving-average the correlation value to obtain a moving average value;
a peak detector to detect a peak value of the moving average value and a peak position thereof for each of the constant periods;
a relative value computation unit configured to obtain a relative value of the peak value with respect to a reference value indicating a moving average value obtained at a time point preceding by a time less than the constant period from the peak position; and
a synchronization determination unit configured to determine a synchronization position using the relative value and the peak position.

12. The receiver according to claim 11, wherein the synchronization determination unit comprises a comparator to compare the relative value with a threshold to detect the peak position corresponding to the relative value exceeding the threshold, and a peak selector to select a latest peak position as the synchronization position.

13. The receiver according to claim 12, which includes a threshold setting unit connected to the comparator and configured to input the threshold to the comparator.

14. The receiver according to claim 11, wherein the relative value computation unit includes means for calculating a difference between the peak value and the reference value to obtain the relative value.

15. The receiver according to claim 11, wherein the relative value computation unit includes means for computing a ratio between the peak value and the reference value to obtain the relative value.

16. The receiver according to claim 11, wherein the peak detector including means for searching for peaks of moving average values in time intervals corresponding to the constant periods to detect peak values and peak positions.

17. The receiver according to claim 16, wherein the relative value computation unit includes means for obtaining a plurality of relative values each representing a relative value of each of the peak values with respect to the reference value indicating a moving average value obtained at a time point preceding by a time less than the constant period from a corresponding one of the peak positions.

18. The receiver according to claim 17, wherein the synchronization determination unit comprises a comparator to compare each of the relative values with a threshold to detect the peak positions corresponding to the relative values exceeding the threshold, and a peak selector to select as the synchronization position a latest peak position from the peak positions.

19. The receiver according to claim 18, which includes a threshold setting unit connected to the comparator and configured to input the threshold to the comparator.

20. The receiver according to claim 17, wherein the relative value computation unit includes means for calculating a difference between the peak value and the reference value to obtain the relative value.

21. The receiver according to claim 17, wherein the relative value computation unit includes means for computing a ratio between the peak value and the reference value to obtain the relative value.

22. The receiver according to claim 11, wherein the burst signal includes an orthogonal frequency division multiply signal including a preamble including the known signal and data following the preamble, and the synchronization determination unit is configured to determine the rearmost end of the preamble as the synchronization position.

23. The receiver according to claim 22, which includes an inverse Fourier transformer to subject a windowed signal component of the orthogonal frequency division multiple signal to an inverse Fourier transformation to separate a subcarrier signal from the orthogonal division multiple signal, the windowed signal component corresponding to an interval of a window having a head coinciding with the synchronization position.
